(19) United States
(12) Patent Application Publication
(10) Pub. No.: US 2026/0291407 A1
(43) Pub. Date: Sep. 24, 2026

(54) CONTINUOUS ROTATING, CASCADING MAGNETIC MOTOR

(71) Applicant: Rodney Kreinbrink, Port Charlotte, FL (US)

(72) Inventor: Rodney Kreinbrink, Port Charlotte, FL (US)

(21) Appl. No.: 19/573,131

(22) Filed: Mar. 20, 2026

Related U.S. Application Data
(60) Provisional application No. 63/775,047, filed on Mar. 20, 2025.

(51) Int. Cl. H02N 11/00

(52) U.S. Cl. CPC H02N 11/002

(57) ABSTRACT

An apparatus for generating electricity comprises a stand supporting a fixed first wheel and a rotatably mounted second wheel on a common spindle. The fixed first wheel carries a plurality of neodymium magnets arranged in a cascading configuration, with each magnet divided into an approaching zone, a passing zone, and a trailing zone. Lead sheeting covers the trailing zone of each magnet to attenuate reverse magnetic attraction, and the trailing edges of all magnets are inclined to facilitate smooth separation as the wheels interact. The second wheel carries magnets arranged in a rotational cascading spiral pattern configured for continuous magnetic interaction with the magnets of the fixed first wheel, producing continuous rotation of the second wheel. A metal collar on the second wheel drives a belt connected to an electrical generator via a tensioner. The apparatus may be oriented vertically or horizontally and may produce AC or DC current.

### CROSS-REFERENCE TO RELATED APPLICATION

This non-provisional utility patent application claims the benefit of and priority to U.S. Provisional Patent Application No. 63/775,047, filed Mar. 20, 2025, the entire disclosure of which is incorporated herein by reference.

### FIELD OF THE INVENTION

The present invention relates generally to apparatus for generating electrical energy. More particularly, the invention relates to a magnetically driven motor apparatus utilizing strategically arranged neodymium magnets on opposing wheel surfaces to produce continuous rotational motion, which is converted into electrical energy by an operatively connected generator.

### BACKGROUND OF THE INVENTION

In the pursuit of sustainable energy solutions, traditional methods such as fossil fuels, solar power, wind, and water have posed significant challenges. These approaches often necessitate substantial infrastructure, are dependent on environmental conditions, and can incur high maintenance costs. Furthermore, they are not universally applicable in all locations, particularly in remote areas or environments where these resources are scarce or unreliable. The demand for a more versatile and self-sustaining energy generation method is evident, as current technologies struggle to provide consistent and efficient power without external inputs.

Existing devices that harness natural forces for energy generation often face limitations in terms of efficiency, reliability, and adaptability. They typically require continuous external inputs such as sunlight or wind, which can be unpredictable and inconsistent. Additionally, these systems may involve complex mechanisms that are prone to wear and require frequent maintenance.

A known challenge in designing magnet-based motors is managing the competing magnetic forces that arise as magnets on opposing surfaces approach, pass, and then trail away from one another. When a magnet on a rotating wheel is attracted to a stationary magnet, the same poles that created the attractive pull can generate a reverse attraction as the magnets pass one another, impeding forward rotation. Additionally, edge polarities of round neodymium magnets can create unwanted side-pull forces. Prior art approaches have attempted to address these problems through various mechanical configurations, but have not provided a streamlined, low-complexity solution.

### Cross Reference to Related Inventions

Power transmission system using magnets, U.S. Pat. No. 11,881,755 B 2Jan. 23, 2024.

A first related prior art reference is directed to a power generation system mounted on at least one triangular-shaped horizontal base on which is placed a cylindrical platform at the center (a primary rotor), and a set of three cylindrical platforms (secondary rotors) surrounding the first rotor. The primary and secondary rotors carry neodymium magnets and are fixed on vertical-axis bearings mounted on said horizontal base. The prior art reference employs a triangular base, a primary rotor surrounded by secondary rotors, pulleys, a toothed belt, and motor reducers—none of which are present in the apparatus of the present invention.

Permanent Magnetic Motor, US Patent Application No. US2021/0336523 A1 Oct. 28. 2021.

A second related prior art reference is directed to a permanent magnet motor in which magnets are arranged in a cylindrical configuration with alternating North and South pole surfaces. A gearbox is mounted to the top of a center shaft and contains a timing gear arrangement. Radial shafts extend from the gearbox, and wheels are mounted on the outer ends of the radial shafts to rotate in a circular pattern over the base magnets. The prior art reference employs a gear-box drive system with outer ring gears, retaining blocks, idler wheels, and numerous beveled gears, and utilizes alternating poles on the base magnets—all of which are absent from and distinct from the present invention, in which all poles of the first, fixed wheel magnets face the same direction.

Electric Power Generating Device, U.S. Pat. No. 10,965,203B 2 . March 30. 2021 A third related prior art reference is directed to an electric power generating device employing a swinging lever assembly provided with a plurality of magnets, in which a rotating shaft drives a crown wheel or gear wheel connected by a transmission chain to a pinion that rotates an alternator. The prior art reference employs a transmission chain, respective transmission ratios, and magnets arranged along the perimeter of the device in a manner fundamentally unlike the cascading, wheel-based arrangement of the present invention.

Accordingly, there remains a need in the art for an apparatus for generating electricity that employs a simplified, two-wheel magnetic interaction in which the problems of reverse magnetic attraction are addressed through a cascading arrangement of magnets divided into approaching, passing, and trailing sections, combined with lead-sheeting attenuation of trailing-section magnetism and angled trailing edges, without the use of triangular bases, complex gearboxes, or transmission chains.

### SUMMARY OF THE INVENTION

The present invention provides a magnetic motor apparatus for generating electricity. The apparatus employs a fixed first wheel carrying a plurality of neodymium magnets arranged in a cascading configuration, and a rotatably mounted second wheel whose magnets are drawn forward by the magnets of the fixed first wheel in a continuous rotational cycle. A metal collar on the second wheel engages a belt connected to an electrical generator, so that the rotation of the second wheel is converted into electrical energy.

In one aspect, the invention provides an apparatus comprising: a stand; a fixed first wheel mounted on the stand and carrying a plurality of neodymium magnets arranged in a cascading configuration divided into approaching, passing, and trailing sections, wherein the trailing section is covered by a lead sheeting layer to attenuate magnetic properties; a rotatably mounted second wheel supported by the stand and having a plurality of magnets configured for magnetic interaction with the magnets of the fixed first wheel; a metal collar on an outer periphery of the second wheel; a belt operatively connected between the metal collar and an electrical generator; and a tensioner configured to impart tension to the belt.

In another aspect, both the fixed first wheel and the rotatably mounted second wheel carry neodymium magnets arranged in a cascading orientation, wherein the magnets on each wheel are inclined at an angle such that trailing edges of opposing magnets gently fall away from one another as the second wheel rotates, thereby reducing reverse magnetic attraction during the trailing phase of interaction.

The foregoing and other features and advantages of the present invention will be more fully understood from the following detailed description of illustrative embodiments, taken in conjunction with the accompanying drawings.

### BRIEF DESCRIPTION OF THE DRAWINGS

The accompanying drawings, which are incorporated in and constitute a part of this specification, illustrate embodiments of the invention and together with the description serve to explain the principles of the invention.

FIG. 1A is a schematic diagram depicting a first example of a naturally occurring cascading spiral crop-circle pattern, showing a five-arm arrangement in which circular formations of varying sizes radiate outward from a center point, serving as the design inspiration for the cascading magnet arrangement of the present invention;

FIG. 1B is a schematic diagram depicting a second example of a cascading crop-circle pattern, showing a six-arm star arrangement in which circles of graduated sizes extend from a central cluster outward in overlapping spiraling arms;

FIG. 1C is a schematic diagram depicting a third example of a cascading crop-circle pattern, showing a single sweeping arc of circles of varying sizes that increase and then decrease from a central cluster, illustrating the continuous multi-scale staggering that inspired the cascading magnet layout of the present invention;

FIG. 1D is a schematic diagram depicting a fourth example of a cascading crop-circle pattern, showing a spiral arrangement of circles organized in concentric ring layers of varying sizes, corresponding to the multi-level radial configuration of the neodymium magnets (30) on the fixed first wheel (26);

FIG. 1E is a schematic diagram depicting a fifth example of a cascading crop-circle pattern, showing a two-arm counter-rotating spiral in which circles graduate in size from small to large along each arm, corresponding to the rotational cascading arm arrangement of the magnets (28) on the rotatably mounted second wheel (24);

FIG. 2 is an exploded assembly elevation view of the magnetic motor apparatus, illustrating the sequence of components from left to right: the rotatably mounted second wheel (24) carrying the metal collar (22) on its outer rim; the pillow bearing (18) on the spindle (20) that mounts the second wheel (24) for free rotation; the fixed first wheel (26) mounted on the spindle (20); and the assembled view showing the second wheel (24) and collar (22) operatively connected via a belt (14) and belt tensioner (16) to the electrical generator (12), with the stand support (10) visible behind the assembled wheel;

FIG. 3 is a schematic front view of the fixed first wheel (26), illustrating an eight-arm radial arrangement of neodymium magnets (30) extending from the center of the wheel toward its perimeter. Each arm carries a row of evenly spaced circular magnets (30) arranged end-to-end in the radial direction. A detail inset below the wheel shows a single magnet (30) in cross-section, divided into three labeled interaction zones: zone A (the approaching section, shown clear), zone B (the passing section, shown with light hatching), and zone C (the trailing section, shown with diagonal hatching indicating the lead sheeting layer applied to that portion of each magnet (30) to attenuate reverse magnetic attraction during the trailing phase);

FIG. 4 is a schematic front view of the rotatably mounted second wheel (24), illustrating the cascading spiral arrangement of neodymium magnets (28) on the facing surface of the second wheel (24). The magnets (28) are arranged in multiple sweeping arms that spiral outward from the center of the wheel toward its perimeter, creating a pinwheel-like cascading pattern. The wheel structure reference numbers (22) and (24) identify the metal collar and wheel disc, respectively. A detail inset below the wheel shows a single magnet (28) in cross-section, with zone B (the passing section) and zone C (the trailing section, shown with diagonal hatching) labeled, illustrating the lead sheeting applied to the trailing section of each magnet (28) on the second wheel (24);

FIG. 5 is a schematic cross-sectional side view illustrating the Approaching Phase of magnetic interaction between the fixed first wheel (26) and the rotatably mounted second wheel (24). The second wheel (24) is represented as the upper horizontal bar and the fixed first wheel (26) as the lower horizontal bar, with the spindle (20) centered between the two bars and pillow bearings (18) shown above the second wheel (24) bar and below the fixed first wheel (26) bar. In the gap between the two bars, two angled rectangular magnet blocks (28) are shown in laterally offset positions to the right of the spindle (20), with the upper magnet (28) projecting downward from the second wheel (24) and the lower magnet (28) projecting upward from the fixed first wheel (26), each tilted at an angle to reflect the inclined trailing-edge geometry of the magnets. The magnets are shown approaching one another as the second wheel (24) moves in the rotational direction;

FIG. 6 is a schematic cross-sectional side view illustrating the Passing Phase of magnetic interaction between the fixed first wheel (26) and the rotatably mounted second wheel (24). The second wheel (24) and fixed first wheel (26) are shown in the same cross-sectional bar format as FIG. 5, with the spindle (20) and pillow bearings (18) as described therein. In the gap between the two bars, two angled rectangular magnet blocks (28) are shown in closer proximity to one another, with the magnets now substantially aligned across the gap as the second wheel (24) magnet passes directly opposite the fixed first wheel (26) magnet. Both magnets (28) are shown with diagonal hatching, illustrating the peak of the attractive interaction as the magnets pass one another;

FIG. 7 is a schematic cross-sectional side view illustrating the Trailing Phase of magnetic interaction between the fixed first wheel (26) and the rotatably mounted second wheel (24). The second wheel (24) and fixed first wheel (26) are shown in the same cross-sectional bar format as FIGS. 5 and 6, with the spindle (20) and pillow bearings (18) as described therein. In the gap between the two bars, two angled rectangular magnet blocks (28) are shown in laterally offset positions to the left of the spindle (20), having passed one another as the second wheel (24) continues in its rotational direction. The trailing section of the upper magnet (28) on the second wheel (24) is shown with diagonal hatching to indicate the lead sheeting applied to that section to attenuate reverse magnetic attraction as the magnets separate; and

FIG. 8 is a schematic front view of the fixed first wheel (26), illustrating an alternative dense cascading magnet configuration in which neodymium magnets of varying sizes are arranged across the entire face of the fixed first wheel (26) in a continuous, tightly packed spiral pattern. The magnets fill the wheel face in a multi-arm cascading arrangement inspired by the crop-circle patterns of FIGS. 1A-1E, with larger magnets toward the outer perimeter and progressively smaller magnets spiraling inward toward the center, providing a high-density magnetic field across the full surface of the fixed first wheel (26).

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

### Overview

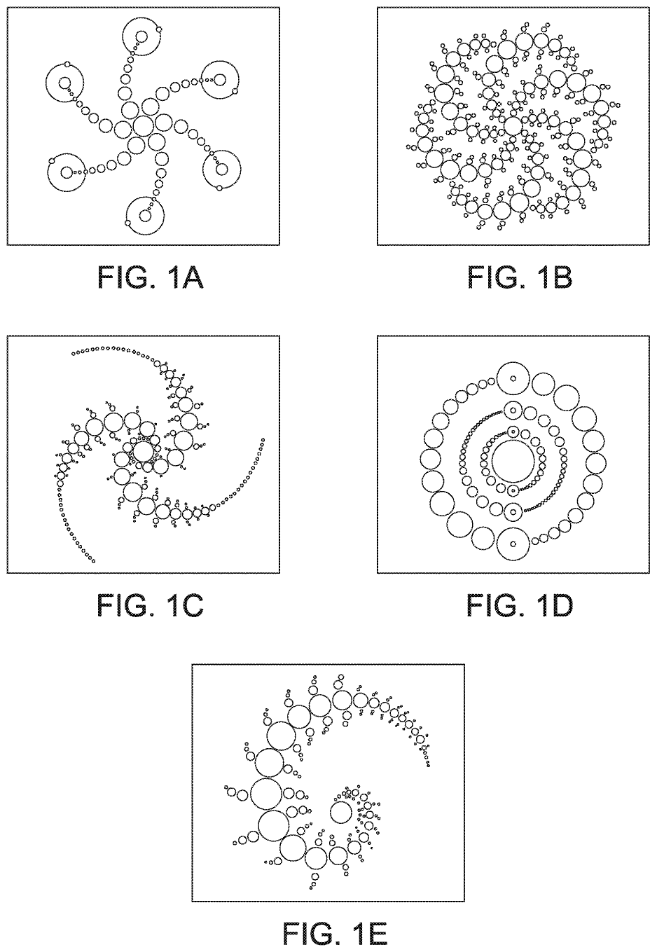

As shown in FIGS. 1A-1E, the cascading magnet arrangement of the present invention is inspired by naturally occurring spiral crop-circle designs—observed patterns in which circles of varying sizes radiate from a center point outward in overlapping and continuous multi-arm formations. FIG. 1A depicts a five-arm radiating spiral; FIG. 1B depicts a six-arm star formation; FIG. 1C depicts a sweeping single-arc arrangement; FIG. 1D depicts a concentric ring layering corresponding to the multi-level radial configuration of the fixed first wheel (26); and FIG. 1E depicts a two-arm counter-rotating spiral corresponding to the rotational cascading arm pattern of the second wheel (24). These patterns inform the spatial arrangement of the neodymium magnets on both wheels—reference number (30) designating the magnets on the fixed first wheel (26) and reference number (28) designating the magnets on the rotatably mounted second wheel (24).

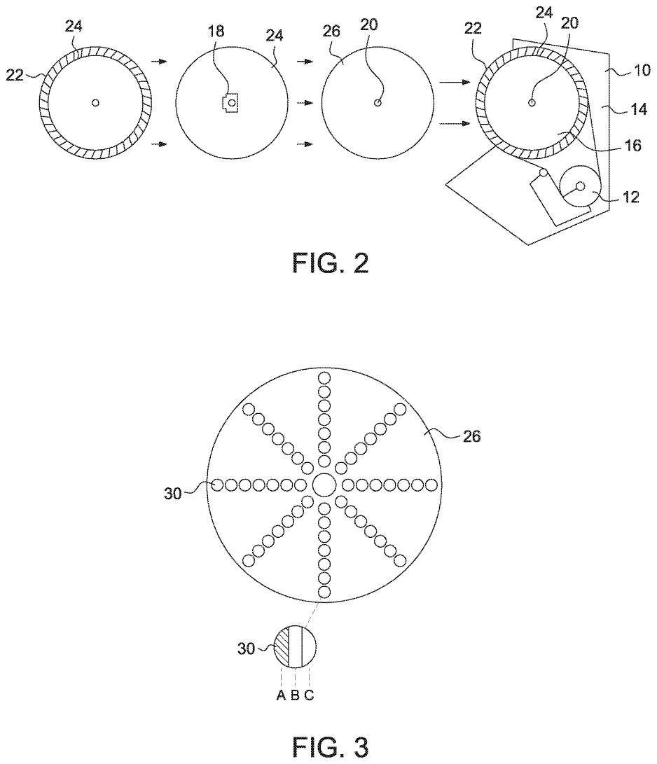

Referring generally to the drawings, and as shown in FIG. 2, the apparatus of the present invention employs two opposing wheel surfaces—a fixed first wheel (26) and a rotatably mounted second wheel (24)—each carrying neodymium magnets arranged in a cascading configuration: magnets (30) on the fixed first wheel (26) and magnets (28) on the second wheel (24). The cascading arrangement creates a sequential magnetic attraction that continuously draws the second wheel (24) forward in a rotational direction. The second wheel (24) in turn drives a belt (14) via a metal collar (22), the belt (14) being operatively connected to an electrical generator (12), thereby converting rotational mechanical energy into electrical energy.

### Stand Support (10)

As shown in FIG. 2, the stand support (10) serves as the structural foundation for the entire apparatus, holding the fixed first wheel (26) in a stationary position while supporting the rotatably mounted second wheel (24) on a spindle (20). In the assembled view of FIG. 2, the stand support (10) is shown as the backing plate visible behind the assembled wheel and collar assembly. The stand (10) may be constructed from lightweight aluminum, providing portability and corrosion resistance suitable for outdoor environments, or from reinforced steel for enhanced durability in industrial settings. The stand (10) may include adjustable height features to accommodate different wheel sizes or operational environments, ensuring the adaptability of the apparatus to various applications. The apparatus may be oriented so that the axis of the spindle (20) is horizontal or vertical, as desired.

### Spindle and Bearing Assembly (20, 18)

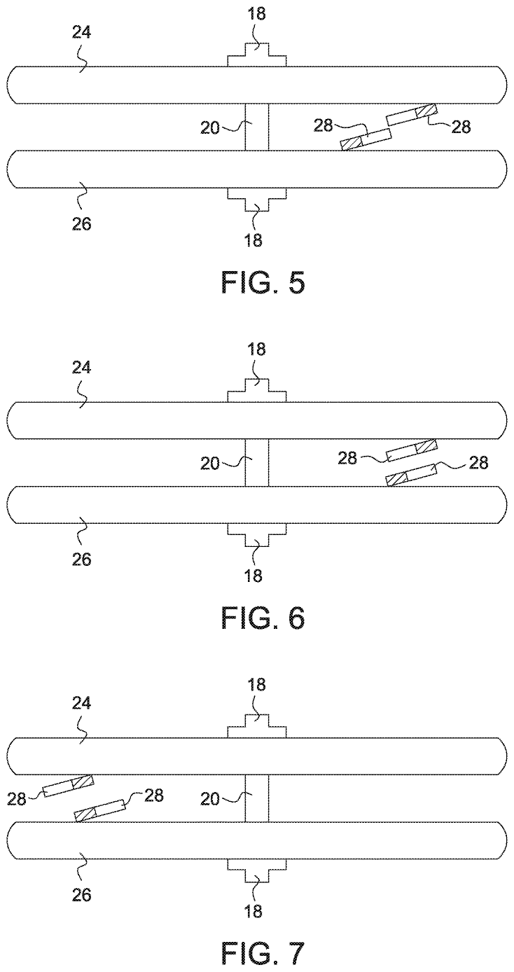

As shown in FIG. 2, both the fixed first wheel (26) and the rotatably mounted second wheel (24) are carried on a common steel rod or spindle (20). The spindle (20) is attached to the stand (10) via a bearing assembly comprising pillow bearings (18), which allow the second wheel (24) to spin freely on the spindle (20) with minimal friction, improving the overall efficiency of the apparatus. In FIG. 2, the pillow bearing (18) is illustrated as the square bearing block with center circle in the second component from the left of the exploded sequence. The fixed first wheel (26) is secured to the spindle (20) so that it does not rotate during operation. The rotatably mounted second wheel (24) is mounted on the spindle (20) via a pillow bearing (18), enabling free and continuous rotation. In FIGS. 5, 6, and 7, the pillow bearings (18) are shown above and below both the fixed first wheel (26) bar and the second wheel (24) bar in the cross-sectional side views.

### Fixed First Wheel (26)

As shown in FIGS. 2, 3, and 5-7, the fixed first wheel (26) is mounted on the stand (10) and held stationary during operation. In FIG. 2, the fixed first wheel (26) is shown as the third component from the left in the exploded sequence—a plain wheel disc with center spindle hole (20) and no collar, illustrating its stationary role. In FIG. 3, the inner face of the fixed first wheel (26) is shown in a front schematic view, carrying a plurality of neodymium magnets (30) arranged in an eight-arm radial configuration, with each arm carrying a row of evenly spaced circular magnets (30) extending from the center to the perimeter of the wheel. A detail inset in FIG. 3 shows a single magnet (30) divided into three labeled zones—A (approaching), B (passing), and C (trailing)—illustrating the three interaction phases that each magnet (30) undergoes. In FIGS. 5, 6, and 7, the fixed first wheel (26) is shown in cross-sectional side view as the lower horizontal bar, with a pillow bearing (18) below it on the spindle (20).

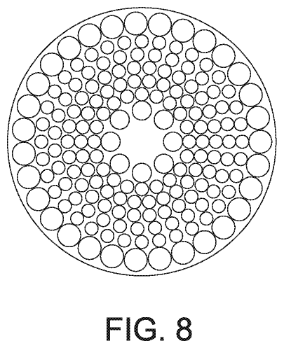

The cascading configuration of the magnets (30) on the fixed first wheel (26) may take the form of a radial arm arrangement, a spiral, concentric rings at varying radial distances, or any other multi-level arrangement in which circles or groups of magnets of varying sizes are staggered at different distances from the center so that multiple radial lines drawn from the center would intersect magnets at different locations within the design, as illustrated in FIGS. 1D, 3, and 8. The alternative dense cascading configuration shown in FIG. 8 illustrates that the magnets (30) may be arranged to fill the entire face of the fixed first wheel (26) with a continuously packed spiral pattern.

As shown in the detail inset of FIG. 3, each neodymium magnet (30) on the fixed first wheel (26) may be conceptually divided into three sections with respect to its interaction with an opposing magnet on the second wheel (24) during rotation: (i) an approaching section (zone A), which is the leading portion where the opposing magnets first draw near to one another and the attractive force is strongest; (ii) a passing section (zone B), which is the central portion where the magnets are substantially directly opposite one another; and (iii) a trailing section (zone C), which is the portion where the magnets are moving away from one another as the second wheel (24) continues to rotate. The detail inset in FIG. 3 shows this three-zone conceptual division, with zone C shown with diagonal hatching to indicate the lead sheeting applied to that section.

All poles of all magnets (30) on the fixed first wheel (26) face the same direction—toward the opposing surface of the second wheel (24)—so that the opposing magnets (28) on the second wheel (24) are always presented with the opposite pole, maintaining an attractive magnetic orientation throughout the approach and passing phases of interaction, as illustrated in FIGS. 5 and 6.

To address the problem of reverse magnetic attraction during the trailing phase of interaction—wherein the same poles that created forward attraction would otherwise tend to hold the magnets together as they attempt to separate—the trailing section (zone C) of each neodymium magnet (30) on the fixed first wheel (26) is covered with lead sheeting, as shown by the diagonal hatching in zone C of the FIG. 3 detail inset and in FIG. 7. The lead sheeting serves to attenuate the magnetic field in the trailing section, thereby reducing the retarding reverse-attraction force and enhancing the forward momentum of the second wheel (24). The thickness of the lead sheeting may vary depending on the strength of the magnets employed: for higher-strength neodymium magnets, thicker lead sheeting (such as 1/16-inch sheeting) may be used; for lower-strength magnets, thinner sheeting or no sheeting may be sufficient. In addition to lead-sheeting attenuation, the trailing edges of the magnets on each wheel are angled or inclined so that they gently fall away from one another during the trailing phase, as illustrated in FIG. 7, further reducing reverse attraction as the magnets separate.

The size, number, and magnetic strength of the neodymium magnets (30) on the fixed first wheel (26) may be varied to adjust the torque and rotational speed of the second wheel (24), and therefore the power output of the electrical generator (12). Larger and stronger magnets provide greater torque suitable for higher-output generators; smaller and lighter magnets provide a more compact arrangement, as illustrated by the varying magnet sizes shown in FIGS. 3 and 8. The discs or wheel surfaces used to hold the magnets in place may be made of composite materials, wood, or other non-metallic materials to avoid introducing polarity interference with the individual wheels.

### Rotatably Mounted Second Wheel (24)

As shown in FIGS. 2, 4, and 5-7, the rotatably mounted second wheel (24) is mounted on the spindle (20) via a pillow bearing (18) so that it rotates freely opposite the inner face of the fixed first wheel (26). In FIG. 2, the second wheel (24) appears twice: first as the leftmost component, showing the metal collar (22) forming the hatched outer rim of the wheel; and second as part of the bearing-mounted component (second from left), showing the pillow bearing (18) centered on the spindle (20). The facing surface of the second wheel (24)—the face directed toward the fixed first wheel (26)—carries neodymium magnets (28) arranged in a rotational and cascading pattern configured to interact with the magnets on the fixed first wheel (26). The magnets (28) on the second wheel (24) are arranged on the facing surface with their poles directed toward the fixed first wheel (26) in the opposite polarity to the magnets on the fixed first wheel (26), so as to create an attractive magnetic interaction (though a repulsive arrangement is also contemplated).

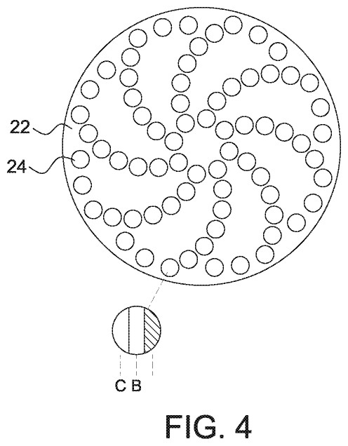

As shown in FIG. 4, the second wheel (24) carries its magnets (28) in a cascading spiral arrangement in which multiple sweeping arms of magnets radiate outward from the center of the wheel in a pinwheel-like pattern. The detail inset in FIG. 4 shows a single magnet (28) with zone B (passing section) and zone C (trailing section, shown with diagonal hatching indicating the lead sheeting) labeled, corresponding to the same three-zone interaction concept as the magnets (30) on the fixed first wheel (26). The rotational cascading design of the second wheel (24) is configured to ensure that at any given moment during rotation, different arms—and therefore different individual magnets (28)—are simultaneously in the approaching phase, the passing phase, and the trailing phase of interaction with the magnets (30) on the fixed first wheel (26), as illustrated in FIGS. 5, 6, and 7, respectively.

As with the fixed first wheel (26), the trailing sections of the magnets (28) on the second wheel (24) may be covered with lead sheeting to attenuate reverse attraction, and the trailing edges of the magnets are angled so as to gently fall away from the opposing magnets as the second wheel (24) rotates, as shown in FIG. 7.

The number of radiating arms, the size of the magnets on the second wheel (24), and the cascading arrangement are designed to work in coordination with the magnet layout of the fixed first wheel (26). The layers of magnets on the fixed first wheel (26) do not need to complete a full circle; they need only be sufficient to create continuous forward movement on the second wheel's magnets. The various spiraling arms of the second wheel (24), through the strength of their neodymium magnets, act upon the magnets of the first wheel (26) to maintain continuous rotation.

### Metal Collar (22), Belt (14), Tensioner (16), and Electrical Generator (12)

As shown in FIG. 2, a metal collar (22) is disposed on the outer periphery—specifically on the reverse, outward-facing side—of the second wheel (24). In FIG. 2, the metal collar (22) is depicted as the hatched outer rim on both the first and last wheel components in the exploded assembly, with the leftmost component showing the collar (22) labeled separately from the wheel disc (24). The metal collar (22) is adapted for engagement with the belt (14). As the second wheel (24) rotates, the metal collar (22) rotates therewith, driving the belt (14).

As shown in the assembled view of FIG. 2, the belt (14) is arranged about the metal collar (22) and is operatively connected to the electrical generator (12). The belt (14) may be made from rubber, polyurethane, or other flexible and durable materials. Also visible in FIG. 2 is the tensioner (16), shown as a small circle below and to the left of the generator (12) in the assembled view. The tensioner (16) is operatively connected to the belt (14) and is configured to impart and maintain tension thereto, preventing slippage and ensuring consistent energy transfer from the rotating second wheel (24) to the electrical generator (12). The tensioner (16) may employ a manual adjustment mechanism or an automatic spring-loaded system.

The electrical generator (12) is operatively connected to the belt (14) and is driven by the rotational energy transmitted through the belt (14) and metal collar (22) from the second wheel (24). In FIG. 2, the generator (12) is shown as the small circle at the lower right of the assembled view. The generator (12) may be configured to produce AC or DC current depending on the requirements of the intended application. The revolution of the motor's wheel in relation to the generator (12) produces the desired electrical output.

### Three-Phase Magnetic Interaction

As shown in FIGS. 5, 6, and 7, the interaction between each opposing pair of neodymium magnets on the two wheels proceeds through three sequential phases, each illustrated as a separate horizontal cross-sectional diagram. In each figure, the rotatably mounted second wheel (24) is represented as the upper horizontal bar, and the fixed first wheel (26) is represented as the lower horizontal bar, with the spindle (20) centered between the two bars and the pillow bearings (18) shown above the second wheel (24) bar and below the fixed first wheel (26) bar.

In FIG. 5 (Approaching Phase), two angled rectangular magnet blocks (28)—one on the second wheel (24) and one on the fixed first wheel (26)—are shown in laterally offset positions to the right of the spindle (20), each tilted at an angle to reflect the inclined trailing-edge geometry of the magnets. As the second wheel (24) moves in its rotational direction, the leading edges of the opposing magnets (28) draw near to one another and the attractive force begins to accelerate the second wheel (24) forward.

In FIG. 6 (Passing Phase), two angled rectangular magnet blocks (28)—one on the second wheel (24) and one on the fixed first wheel (26)—are shown in the gap between the two bars, in closer proximity and substantially aligned with one another as the magnets pass. Both magnets (28) are shown with diagonal hatching. A double-headed arrow between the two magnets (28) indicates the peak attractive force during this phase. The second wheel (24) continues forward momentum through the peak of the interaction.

In FIG. 7 (Trailing Phase), two angled rectangular magnet blocks (28) are shown in laterally offset positions to the left of the spindle (20), having passed one another as the second wheel (24) continues in its rotational direction. The trailing section of the upper magnet (28) on the second wheel (24) is shown with diagonal hatching indicating the lead sheeting applied to attenuate the reverse magnetic field. The lead sheeting on the trailing sections and the angled trailing edges cooperate to attenuate reverse attraction and allow the magnets to separate with reduced retarding force.

Due to the cascading design of both wheels—as depicted in FIGS. 1D, 3, and 8 for the fixed first wheel (26) and in FIGS. 1E and 4 for the second wheel (24)—the magnets (30) on the fixed first wheel (26) and the magnets (28) on the second wheel (24) are continuously in all three phases of interaction simultaneously as the second wheel (24) rotates. The multitude of arms on the second wheel (24), combined with the multi-level cascading arrangement on the fixed first wheel (26), smooths out any irregularities in the design and maintains consistent rotational momentum.

### Alternatives and Variations

While the foregoing embodiments describe the use of magnetic attraction between opposing poles on the two wheels, the apparatus may alternatively be configured to use magnetic repulsion between like poles, where desired. The apparatus may be oriented vertically or horizontally. The size and magnetic strength of the neodymium magnets (30) on the fixed first wheel (26) and the magnets (28) on the second wheel (24) may be the same or may differ; using smaller magnets on the rotating second wheel (24) in conjunction with larger magnets on the fixed first wheel (26) may provide a larger effective ‘sweet spot’ in terms of minimizing unwanted reverse attraction during the trailing phase, as reflected in the varying magnet sizes depicted in FIGS. 3, 4, and 8. The wheel discs may be made of wood, composite materials, or any other non-metallic material suitable to avoid polarity interference.

It should be understood that the foregoing relates to exemplary embodiments of the invention and that modifications may be made without departing from the spirit and scope of the invention as set forth in the following claims.

What is claimed is:

1. An apparatus for generating electricity, comprising:
a stand;
a fixed first wheel mounted on the stand, the fixed first wheel having a facing surface carrying a plurality of neodymium magnets arranged in a cascading configuration, each of the plurality of neodymium magnets being divisible into an approaching section, a passing section, and a trailing section with respect to rotation of a second wheel, wherein a lead sheeting layer is disposed over the trailing section of each of the plurality of neodymium magnets to attenuate the magnetic field thereof;
the second wheel rotatably mounted on the stand and having a facing surface directed toward the facing surface of the fixed first wheel, the second wheel carrying a plurality of magnets configured for magnetic interaction with the plurality of neodymium magnets of the fixed first wheel, the magnets of the second wheel being arranged in a rotational cascading pattern configured to produce continuous rotation of the second wheel;
a metal collar disposed on an outer periphery of the second wheel and adapted for engagement with a belt;
a belt arranged about the metal collar and operatively connected to an electrical generator; and
a tensioner operatively connected to the belt and configured to impart tension thereto.

2. The apparatus of claim 1, wherein the trailing edges of the neodymium magnets on the fixed first wheel are inclined at an angle such that opposing magnets on the fixed first wheel and the second wheel gently fall away from one another during the trailing phase of magnetic interaction, thereby reducing reverse magnetic attraction.

3. The apparatus of claim 1, wherein the plurality of neodymium magnets on the fixed first wheel are arranged so that all poles of all said magnets face in a same direction toward the second wheel.

4. The apparatus of claim 1, wherein the cascading configuration of the neodymium magnets on the fixed first wheel comprises multiple levels of magnets at varying radial distances from a center of the fixed first wheel, the magnets being staggered relative to one another such that a plurality of radial lines drawn from the center intersect magnets at different locations within the arrangement.

5. The apparatus of claim 1, wherein the rotational cascading pattern of the magnets of the second wheel comprises a plurality of radiating arm-like arrangements extending from a center toward a perimeter of the second wheel, the arm-like arrangements being angularly offset from one another such that at any given rotational position, at least one arm is simultaneously in the approaching phase, at least one arm is in the passing phase, and at least one arm is in the trailing phase of interaction with the neodymium magnets of the fixed first wheel.

6. The apparatus of claim 1, wherein a thickness of the lead sheeting layer varies in correspondence with the magnetic strength of the neodymium magnets, such that a thicker lead sheeting layer is employed with stronger neodymium magnets.

7. The apparatus of claim 1, wherein the magnets of the second wheel also carry a lead sheeting layer over their trailing sections to attenuate reverse magnetic attraction.

8. The apparatus of claim 1, wherein the stand is constructed from aluminum.

9. The apparatus of claim 8, wherein the stand includes adjustable height features to accommodate different wheel sizes or operational environments.

10. The apparatus of claim 1, wherein the neodymium magnets of the fixed first wheel and the magnets of the second wheel are arranged to interact by magnetic attraction, the poles of the neodymium magnets of the fixed first wheel facing the second wheel being opposite in polarity to the poles of the magnets of the second wheel facing the fixed first wheel.

11. The apparatus of claim 1, wherein the magnetic strength of the neodymium magnets on the fixed first wheel and the magnets on the second wheel are selectable to adjust the torque and energy output of the apparatus.

12. The apparatus of claim 1, wherein the apparatus is configurable to operate in a vertical orientation or a horizontal orientation.

13. The apparatus of claim 1, wherein the electrical generator is configured to produce AC current.

14. The apparatus of claim 1, wherein the electrical generator is configured to produce DC current.

15. The apparatus of claim 1, wherein the second wheel and the fixed first wheel are both mounted on a common spindle, and wherein the second wheel is mounted on the spindle via a bearing assembly comprising pillow bearings that permit the second wheel to rotate freely relative to the spindle while the fixed first wheel is held stationary on the spindle.

16. An apparatus for generating electricity, comprising:
a stand;
a fixed first wheel and a rotatably mounted second wheel both carried on a common spindle supported by the stand, the fixed first wheel being held stationary and the second wheel being mounted on the spindle via a bearing assembly comprising pillow bearings;
a plurality of neodymium magnets arranged in a cascading, multi-level configuration on a facing surface of the fixed first wheel, wherein all poles of said plurality of neodymium magnets face in a common direction toward the second wheel, and wherein trailing edges of said neodymium magnets are inclined to facilitate separation of opposing magnets with reduced reverse-attraction force;
a plurality of magnets arranged on a facing surface of the second wheel in a rotational cascading pattern configured to interact with the plurality of neodymium magnets of the fixed first wheel by magnetic attraction and to produce continuous rotation of the second wheel about the spindle; and
a power transmission assembly comprising a metal collar on an outer periphery of the second wheel, a belt operatively connecting the metal collar to an electrical generator, and a tensioner configured to maintain tension in the belt.

17. The apparatus of claim 16, wherein the trailing section of each of the neodymium magnets of the fixed first wheel is covered with a lead sheeting layer to attenuate the magnetic field of the trailing section.

18. The apparatus of claim 16, wherein the plurality of magnets on the second wheel are arranged in a plurality of radiating arm-like arrangements angularly offset from one another such that at any given rotational position of the second wheel, the magnets of the second wheel are simultaneously in approaching, passing, and trailing phases of magnetic interaction with the neodymium magnets of the fixed first wheel.

19. The apparatus of claim 16, wherein the wheel surfaces of the fixed first wheel and the second wheel are formed of a non-metallic material.

20. The apparatus of claim 16, wherein the cascading multi-level configuration of the neodymium magnets on the fixed first wheel is a spiral configuration.
